(19) United States
(12) Patent Application Publication
(10) Pub. No.: US 2001/0035176 A1
(43) Pub. Date: Nov. 1, 2001

(54) Barbecue pit

(76) Inventor: Thomas Jefferson Bush III, Gary, IN (US)

Correspondence Address: Thomas Jefferson Bush III, 2022 Taft Street, Gary, IN, 46404, US

(21) Appl. No.: 09/815,794

(22) Filed: Mar. 23, 2001

Related U.S. Application Data
(60) Provisional application No. 60/192,430, filed on Mar. 28, 2000.

(51) Int. Cl. A47J 37/00

(52) U.S. Cl. 126/25 R; 126/245

(57) ABSTRACT

A barbecue pit with a removable fire box which facilitates cleanup.

### CROSS REFERENCES TO RELATED APPLICATIONS

Provisional Application for Patent No. 60/192,430 of Mar. 28, 2000, with the same title: “Barbecue Pit” which is hereby incorporated by reference. Applicant claims priority of the Provisional Application pursuant to 35 U.S.C. Par. 119(e)(i).

Statement as to Rights to inventions made under Federally sponsored research and development: Not applicable.

### BACKGROUND OF THE INVENTION

1. Field of the Invention

This invention relates to a barbecue pit that incorporates a provision for a water bed under a fire grate. The water bed is contained in a removable box.

2. Background Information

It is more fun barbecuing and eating barbecue than cleaning out the barbecue pit. In commercial establishments, grease from barbecued meat drips down past the charcoal and accumulates in the area around the barbecue pits. This condition attracts rats. Rats are a problem in commercial barbecue establishments that frustrates both the barbecue pit establishment operators as well as the local boards of health. Even home barbecue pits are difficult to clean.

As will be seen from the subsequent description, the preferred embodiments of the present invention overcome these and other shortcomings of prior art.

### SUMMARY OF THE INVENTION

The present invention is an apparatus useful as a barbecue pit comprising a hood with a vent pipe, an enclosure, an upper enclosure, said upper enclosure comprising doors and door guides, a food grill, a fuel grill, and a fire box that is removable from said barbecue pit. The fire box comprises the fuel grill. The fire box permits the addition of water, that forms a layer at the bottom of the fire box, that catches any grease falling from food that is on the food grill. Charcoal ashes, formed as charcoal on the fuel grill burns, fall into the water at the bottom of the fire box. The fire box, being removable form said barbecue pit, is relatively cleanable as compared to prior art barbecue pits.

### BRIEF DESCRIPTION OF THE DRAWINGS

FIG. 1 illustrates a preferred embodiment of the present invention, a commercial barbecue pit.

FIG. 1A illustrates a fire box and a fuel grate from FIG. 1.

FIG. 2 illustrates an alternate embodiment of the present invention, a consumer barbecue pit.

FIG. 2A illustrates a fire box and a fuel grate from FIG. 2.

### DESCRIPTION OF THE PREFERRED EMBODIMENTS

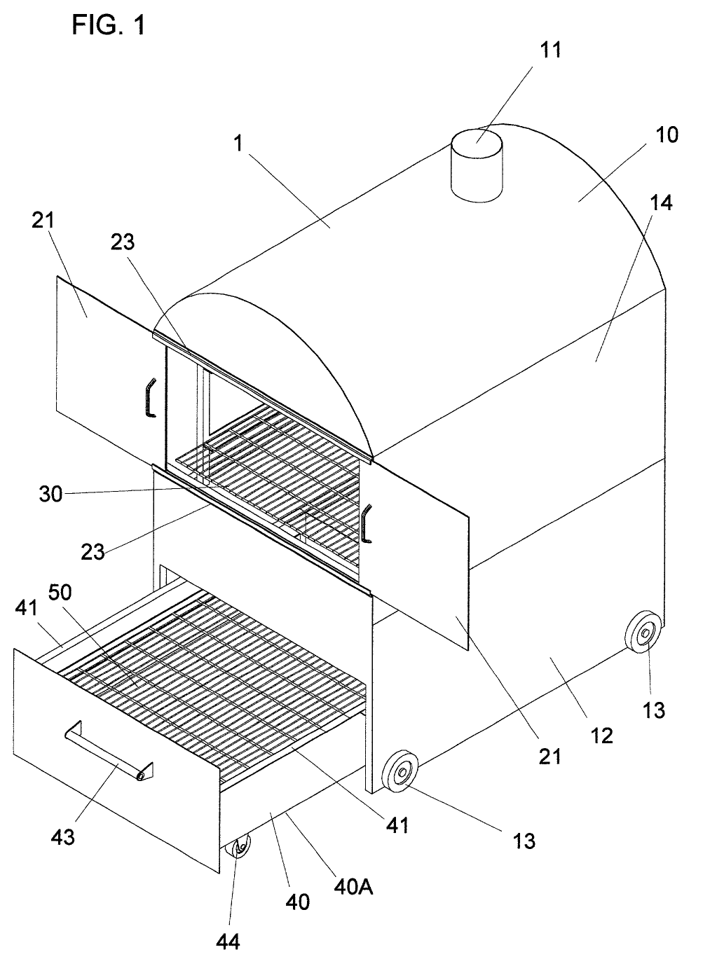

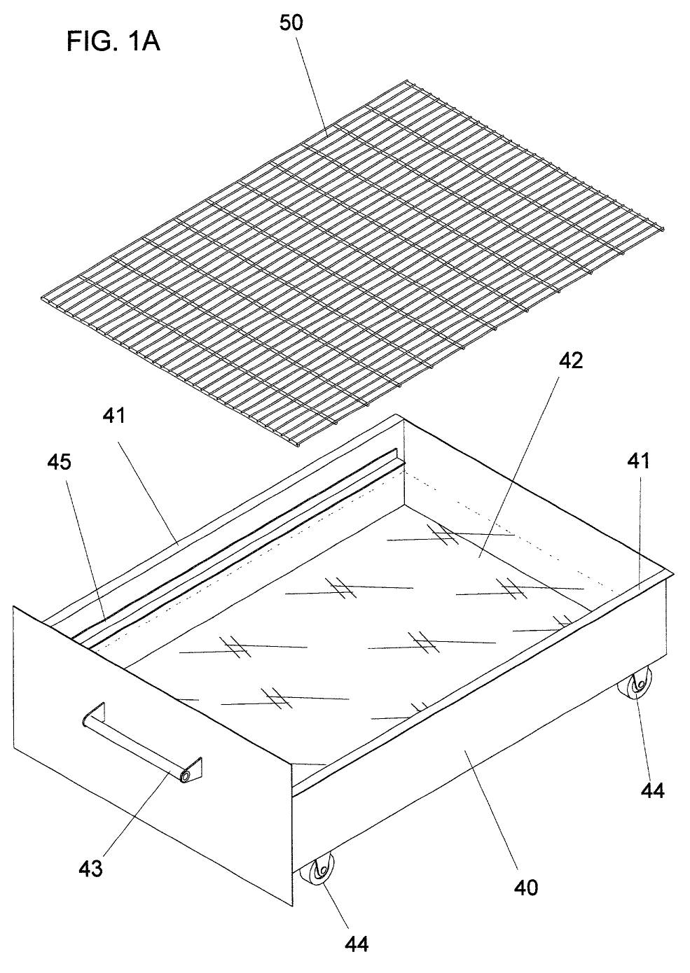

FIGS. 1 and 1A illustrate the preferred embodiment of the present invention, an apparatus useful as a barbecue pit, which is a commercial barbecue pit 1 comprising a hood 10 with a vent pipe 11, an upper enclosure 14, an enclosure 12, a food grill 30, a fuel grate 50, wheels 13, and a fire box 40.

The upper enclosure 14 comprises sliding doors 21 and door guides 23.

The food grill 30 is located at the top of the enclosure 12. The upper enclosure 14 rests atop the enclosure 12. The fire box 40 is removable from said pit 1, said fire box 40 comprising a handle 43 and supports 44. The supports 44 are wheels, in the preferred embodiment of the present invention.

The fire box 40, has a watertight bottom 40A so a layer of water 42 can be poured into the fire box 40, to a depth of approximately one inch. The fuel grate 50 is located in, and is removable from the fire box 40. The fuel grate 50 is located within the fire box 40 so there is enough room between the fuel grate 50 and the enclosure 12 for a layer of charcoal.

In the preferred embodiment of the present invention, the fuel grate 50 rests on brackets 45, one of which is depicted in FIG. 1A.

In the preferred embodiment of the present invention, water 42 is poured into the fire box 40, to a depth of approximately one inch. Charcoal is placed on the fuel grate 50 and ignited. The fire box 40 is shoved into the enclosure 12. Food to be barbecued is placed on the food grill 30. The sliding doors 21 can be slid open or closed. While hinged doors would work, the sliding doors 21 save space. The sliding doors 21 provide access to the food on the food grill 30 by a barbecuer. As the charcoal burns, charcoal ashes fall through the fuel grate 50 into the water 42 below. After barbecuing, the fire box 40 can be pulled out from the enclosure 12 by the handle 43 for cleaning. All grease from the food is collected in the fire box 40 from which said grease is more easily removable than if the fire box 40 was not removable.

Applicant has found that cooking time for meat is halved by the action of steam generated from the water 42 by heat from burning charcoal. This is an advantage of the present invention.

One can immerse any charcoal on the fuel grate 50 by adding sufficient water 42 into the fire box 40. This extinguishes burning charcoal.

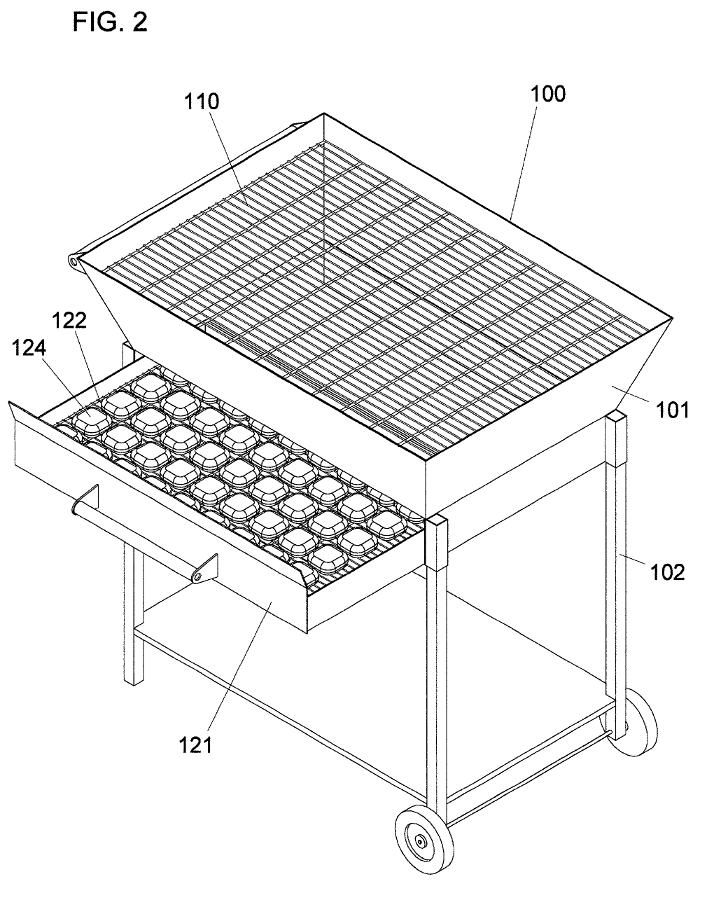

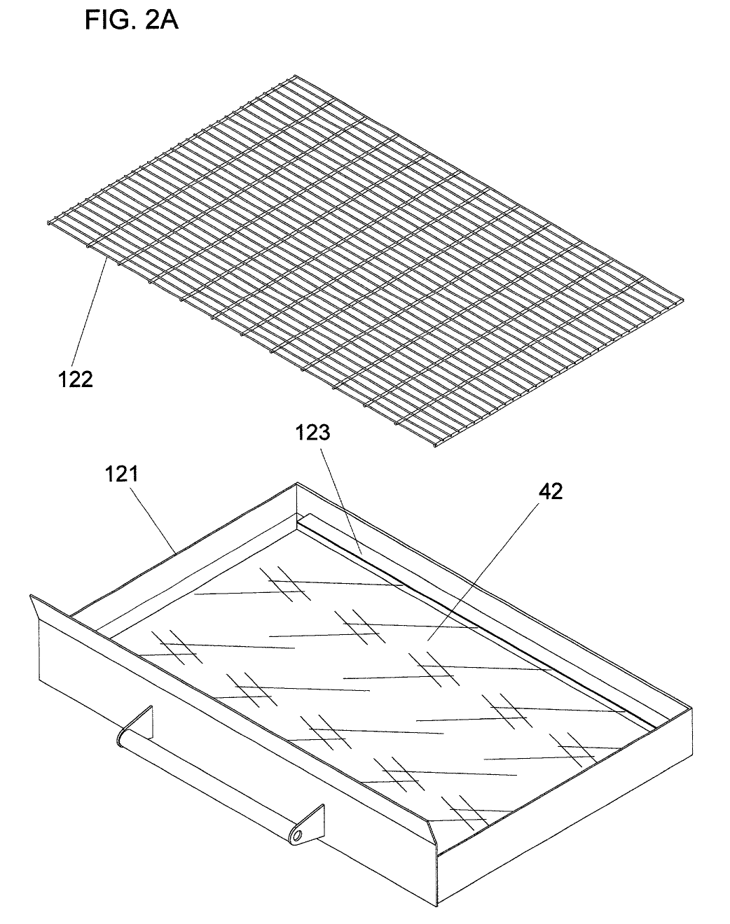

FIGS. 2 and 2A illustrates an alternate embodiment of the present invention, a consumer barbecue pit 100 comprising a consumer enclosure 101, a consumer food grill 110, a stand 102, and a consumer fire box 121. Said fire box 121 comprises a consumer fuel grate 122 and brackets 123, one of which said brackets 123 is shown in FIG. 2A.

Said grate 122 is contained in said fire box 121, resting on said brackets 123 one of which brackets 123 is shown as affixed to said fire box 121.

Said fire box 121 will hold water 42, and in use, a one inch or so layer of water 42 is poured into said fire box 121. Charcoal 124 is shown on said fuel grate 122. Said fire box 121 is contained in, and removable from, said enclosure 101.

To operate the consumer barbecue pit 100, one pours water 42 into said fire box 121 to a depth of one inch or so, then places charcoal 124 on said fuel grate 122 and ignites said charcoal 124. Said fire box 121 is shoved into said enclosure 101 and food to be barbecued is placed on said food grill 110. As the charcoal 124 burns, charcoal ash falls into the water 42. Grease from the food falls into the water 42 in said fire box 121. When one wants to extinguish a fire, said fire box 121 is a convenient repository for additional water 42. By having the charcoal 124 low enough in said fire box 121, one is assured of extinguishing any fire left in said charcoal 122 by the addition of sufficient water 42 into said fire box 121.

When the barbecue is completed, said fire box 121 can be removed for cleaning.

In the prefered embodiment of the present invention, the materials of construction are of metal, preferrably of steel.

Although the description above contains many specificities, these should not be construed as limiting the scope of the invention but as merely providing illustrations of some of the presently preferred embodiments of this invention.

Thus the scope of the invention should be determined by the appended claims in the formal application and their legal equivalents, rather than by the examples given.

I claim:

1. An apparatus useful as a barbecue pit, said apparatus comprising:
a) a food grill,
b) an enclosure, and
c) a fire box, said fire box comprising a fuel grate,
wherein said food grill rests atop said enclosure,
wherein the fire box is contained in, and removable from, said enclosure, and
wherein a layer of water can be poured into said fire box, said layer of water serving to receive charcoal ashes as charcoal placed on said fuel grate burns, as well as grease dripping from food placed on said food grill.
